(19) United States
(12) Patent Application Publication
(10) Pub. No.: US 2014/0210343 A1
(43) Pub. Date: Jul. 31, 2014

(54) SYSTEM AND METHOD FOR CONTROLLING HEADLAMPS OF VEHICLE

(71) Applicant: Caterpillar Global Mining LLC, South Milwaukee, WI (US)

(72) Inventors: Sathishkumar C. Kulandaivellu, Coimbatore (IN); V. Ramakrishna Challa, Narasaraopet (IN)

(73) Assignee: Caterpillar Global Mining LLC, South Milwaukee, WI (US)

(21) Appl. No.: 14/230,190

(22) Filed: Mar. 31, 2014

(51) Int. Cl. B60Q 1/08

(52) U.S. Cl. CPC B60Q 1/085
USPC 315/82

(57) ABSTRACT

A method for controlling high-beam lamp state in a vehicle is disclosed. The method includes activating the high-beam lamp state of the vehicle. Further, the method includes receiving a first output signal from a high-beam sensor, the first output signal being indicative of an intensity of light from a light source facing the vehicle. The method includes receiving a second output signal from a stray light sensor, the second output signal being indicative of an intensity of stray light from a stray light source in vicinity of the vehicle. The method includes receiving a speed signal from a ground speed sensor associated with the vehicle, the speed signal being indicative of a ground speed of the vehicle. Furthermore, the method includes selectively deactivating the high-beam lamp state of the vehicle based on at least one or more of the first output signal, the second output signal, and the speed signal.

### TECHNICAL FIELD

The present disclosure generally relates to head lamps of a vehicle, and more particularly relates to a system and method for controlling the illumination of head lamps.

### BACKGROUND

Vehicles include a variety of different headlamps to provide illumination under different operating conditions. Headlamps are controlled to alternately generate low beams and high beams. Low beams provide less illumination and are used at night to illuminate the forward path when other vehicles are present. High beams output significantly more light and are used to illuminate the vehicle's forward path when other vehicles are not present. However, switching between the high beam and the low beam of the headlamps may prove to be very important when driving on highways, or other accident prone areas.

Generally, the operator of the vehicle switches manually from the high beam to the low beam as and when required. However, sometimes the operators tend to forget, or may be lazy to switch the high beam to low beam of the headlamps, which is not safe.

United States Publication Number 2006/0152935 relates to an interactive headlight control system providing a vehicle on which it is installed means for remotely automatically controlling headlights of other surrounding vehicles by sending outgoing remote-action signals. More particularly, the headlight control system provides the vehicle on which it is installed the ability of automatically switching headlights of other surrounding vehicles by remote control from their high position to their low position, and to maintain their headlights in low position, even if they have manually been set to high position. The headlight control system also provides means for receiving and reacting to such signals.

### SUMMARY OF THE DISCLOSURE

In an aspect of the present disclosure, a method for controlling high-beam lamp state in a vehicle is disclosed. The method includes activating the high-beam lamp state of the vehicle. Further, the method includes receiving a first output signal from a high-beam sensor, the first output signal being indicative of an intensity of light from a light source facing the vehicle. The method includes receiving a second output signal from a stray light sensor, the second output signal being indicative of an intensity of stray light from a stray light source in vicinity of the vehicle. The method includes receiving a speed signal from a ground speed sensor associated with the vehicle, the speed signal being indicative of a ground speed of the vehicle. Furthermore, the method includes selectively deactivating the high-beam lamp state of the vehicle based on at least one or more of the first output signal, the second output signal, and the speed signal.

In another aspect, a controller for an auto-dipping system associated with a head lamp of a vehicle is provided. The controller is configured to activate the high-beam lamp state of the vehicle. Further, the controller is configured to receive a first output signal from a high-beam sensor, the first output signal being indicative of an intensity of light from a light source facing the vehicle. The controller receives a second output signal from a stray light sensor, the second output signal being indicative of an intensity of stray light from a stray light source in vicinity of the vehicle. The controller receives a speed signal from a ground speed sensor associated with the vehicle, the speed signal being indicative of a ground speed of the vehicle. Furthermore, the controller selectively deactivates the high-beam lamp state of the vehicle based on at least one or more of the first output signal, the second output signal, and the speed signal.

Other features and aspects of this disclosure will be apparent from the following description and the accompanying drawings.

### BRIEF DESCRIPTION OF THE DRAWINGS

FIG. 1 illustrates a perspective view of an exemplary vehicle having a system for controlling headlamps of the vehicle, according to an aspect of the present disclosure;

FIG. 2 is a diagrammatic representation of an exemplary environment in which two vehicles are shown approaching each other;

FIG. 3 is a diagrammatic representation of the environment having a stray light source;

FIG. 4 is a block diagram of the system for controlling the headlamps of the vehicle; and

FIG. 5 is a flowchart of a method for controlling the head lamps of the vehicle.

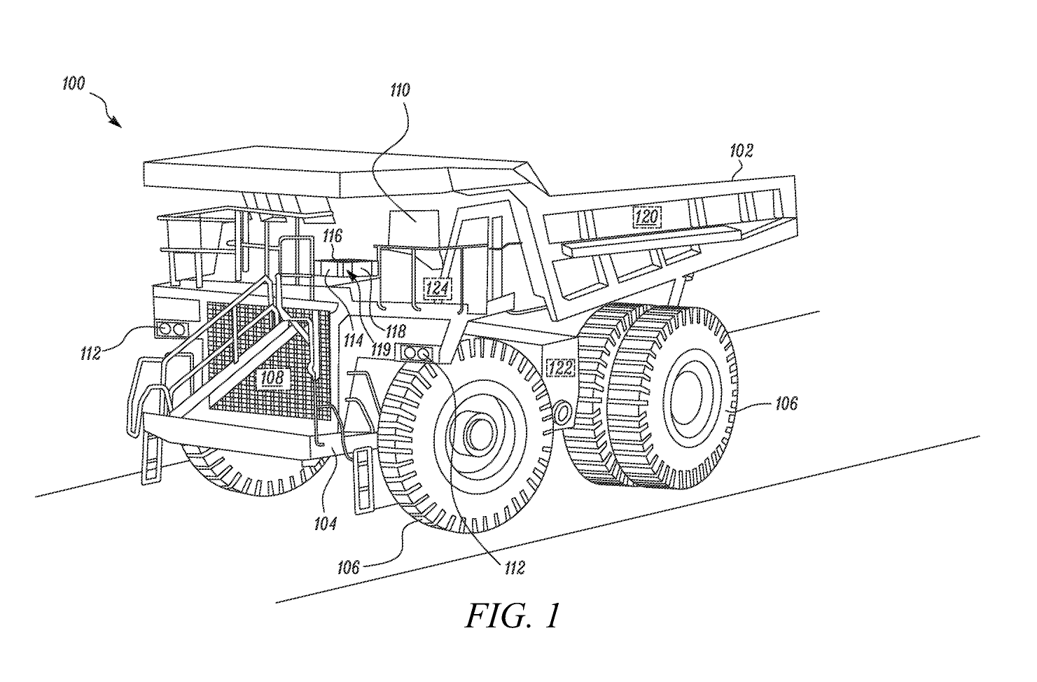

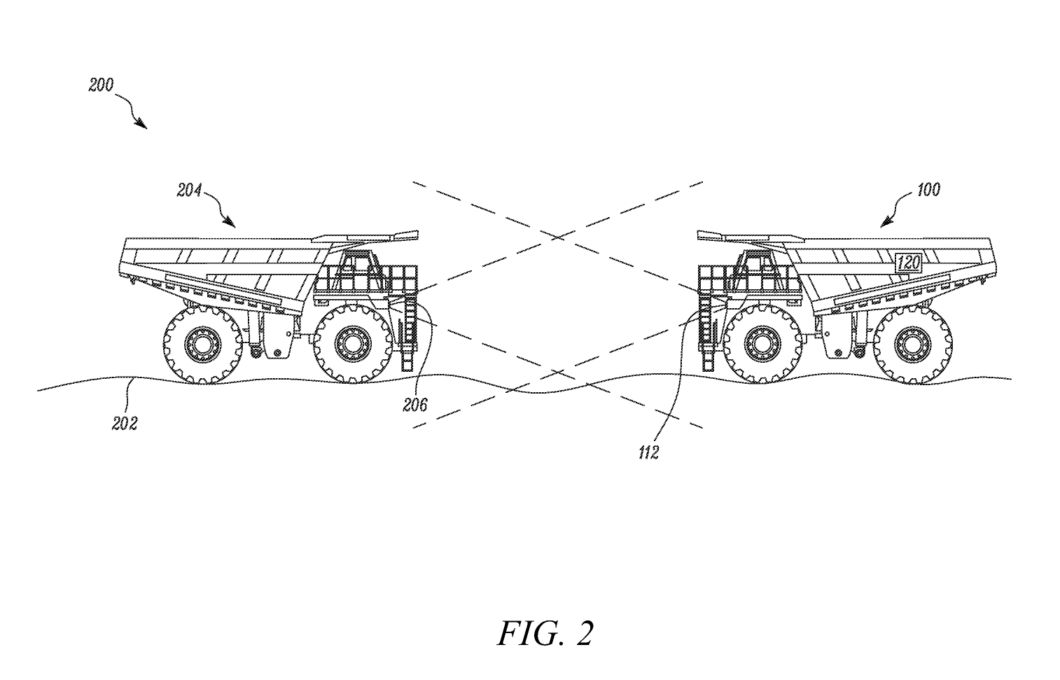

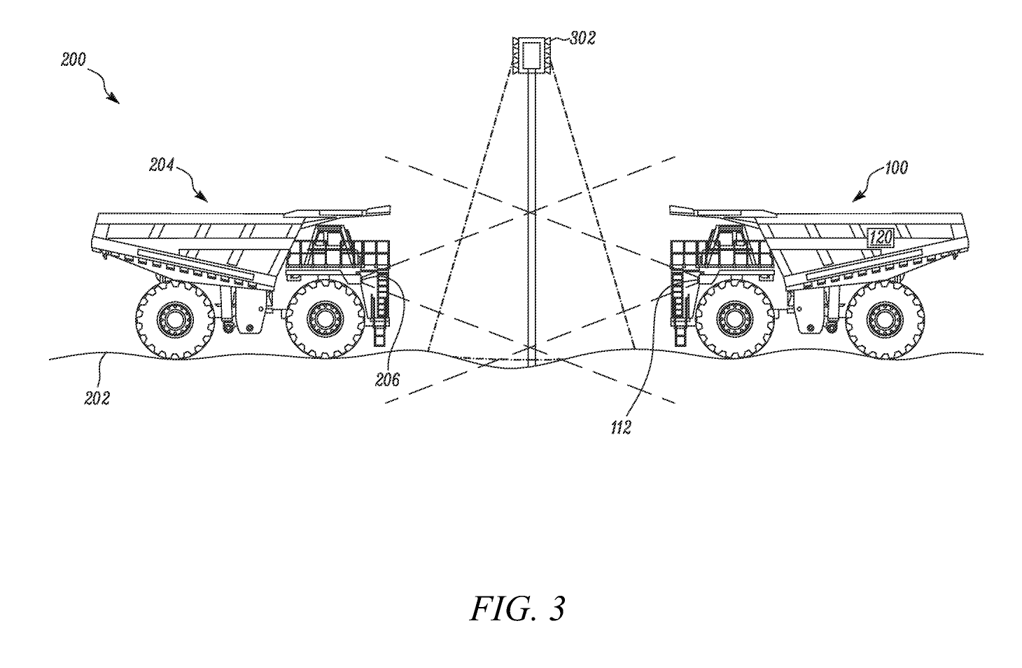

### DETAILED DESCRIPTION

Wherever possible, the same reference numbers will be used throughout the drawings to refer to the same or the like parts. The present disclosure relates to a system for controlling headlamps of a vehicle. FIG. 1 illustrates a perspective view of an exemplary vehicle 100, according to an embodiment of the present disclosure. FIGS. 2 and 3 illustrate a diagrammatic representation of an exemplary environment 200 on which the vehicle 100 operates. The environment 200 may include a highway road 202, hereinafter referred to as the road 202. Alternatively, the environment 200 may be a worksite including a road 202, or a street, etc., on which the vehicle 100 moves and/or operates.

Referring again to FIG. 1, the vehicle 100 may be a haul truck having a payload carrier 102. The vehicle 100 may be used to transport material such as sand, gravel, stones, soil, excavated material, and the like from one location to another location at the worksite or outside the worksite. It is envisioned that the present disclosure includes various alternative embodiments, such as the vehicle 100 may be any vehicle such as a car, a bus, a truck, a backhoe loader, a front shovel, a dragline excavator, moving on the road 202.

The vehicle 100 may include a frame 104, wheels 106, and an engine compartment 108 located within the frame 104 and positioned at the front of the vehicle 100. The vehicle 100 may also include an engine (not shown) disposed within the engine compartment 108. The engine may be an internal combustion engine, a hybrid engine, a non-conventional power source like batteries, or any other power source known by those of ordinary skill in the art. The vehicle 100 may further include an operator cab 110 mounted on the frame 104. The operator cab 110 may also include operator input devices (not shown) to control the movement and the operation of the vehicle 100 as is customary. Furthermore, the vehicle 100 includes headlamps 112 disposed on the frame 104 and each being spaced apart relative to each other and adjacently positioned along out margins of the cab 110 of the vehicle 100. The headlamp 112 includes a high beam lamp which may be activated to an ON state and/or deactivated to an OFF state.

In an embodiment, the vehicle 100 includes a high-beam sensor 114, a first stray light sensor 116 and a second stray light sensor 118. The high-beam sensor 114 and the first and second stray light sensors 116, 118 are disposed in the operator cab 110. In an exemplary embodiment, the sensors 114, 116, and 118 are disposed in a sensor unit 119 and optimally oriented to capture light intensity from an opposite light source or a stray light source. Further, the sensors 114, 116, and 118 may have respective ranges to effectively detect the various light sources and in specific the first and the second stray light sensors 116, 118 are oriented towards the sky. The high-beam sensor 114, the first stray light sensor 116 and the second stray light sensor 118 are active sensors configured to receive light intensity as input and provide a Pulse Width Modulated (PWM) signal or a varying frequency output signal as output corresponding to the light intensity inputs. It may be contemplated that the output of the sensors 114, 116 and 118 is in the form of pulsed output or square or sine wave.

Furthermore, the vehicle 100 includes a positioning system 120 configured to detect a position of the vehicle 100 within the environment 200. It is contemplated that the position of the vehicle 100 may be indicative of location co-ordinates of the vehicle 100. It will be apparent to a person having ordinary skill in the art that the positioning system 120 may be a Global Navigation Satellite System, a Global Positioning System, any other Satellite Navigation System, an Inertial Navigation System, an Augmented Navigation System, any other known positioning system, or a combination thereof.

As shown in FIGS. 2 and 3, the environment 200 may include a second vehicle 204 approaching towards the vehicle 100 when the vehicle 100 is moving on the road 202. It may be contemplated that the second vehicle 204 may be same as the vehicle 100 or may be any other type of vehicle moving on the road 202. In various exemplary embodiments, the second vehicle 204 may be a haul truck, backhoe loader, a front shovel, a dragline excavator, or a car. Further, the second vehicle 204 may have a headlamp 206, such that the headlamp 206 acts as a light source facing the vehicle 100 on the road 202. The second vehicle 204 may further include a second positioning system (not shown) configured to transmit the position information of the second vehicle 204.

The high-beam sensor 114 (as shown in FIG. 1) is configured to detect light from the headlamp 206 of the vehicle 204 approaching towards the vehicle 100. Similarly, each of the stray light sensors 116, 118 are configured to detect light from one or more stray light sources, such as stray light source 302 (as shown in FIG. 3) in the vicinity of the vehicle 100. Examples of the stray light source 302 may include lamp posts, street lights, moon light, etc.

The high-beam sensor 114 is configured to generate a first output signal based on the intensity of light detected from the light source facing the vehicle 100, i.e., from the headlamp 206 of the second vehicle 204. Furthermore, the stray light sensors 116, 118 are configured to generate a second output signal based on an intensity of stray light detected from the stray light source 302 in the vicinity of the vehicle 100.

The vehicle 100 includes a ground speed sensor 122 configured to determine a ground speed of the vehicle 100. For example, the ground speed sensor 122 may be associated with the wheels 106 and the speed of the vehicle 100 may be based on a rotational speed of the wheels 106.

A controller 124 is provided in the vehicle 100 and configured to control illumination of the headlamps 112 of the vehicle 100. The controller 124 is configured to activate the high-beam lamp state of the headlamp 112 such that it is ON. Further, the controller 124 is configured to receive the first output signal from the high-beam sensor 114 and the second output signal from the stray light sensors 116, 118. In an exemplary embodiment, the first and the second output signal are PWM signals having the pulsed output. In an alternative embodiment, the first and the second output signals may be the variable frequency square or sine wave. Furthermore, the controller 124 is configured to receive a speed signal from the ground speed sensor 122 of the vehicle 100.

The controller 124 is configured to selectively deactivate the high-beam lamp state of the headlamps 112 based on the first output signal from the high-beam sensor 114, the second output signal from the sensors 116, 118 and the speed signal from the ground speed sensor 122.

The controller 124 may communicate with the positioning system 122 of the vehicle 100 and with the positioning systems of other vehicles, such as the second vehicle 204 over a network (not shown) to determine the position information of the vehicle 100 and the other vehicles within the environment 200. Based on the position information of the other vehicles, such as the second vehicle 204, the controller 124 is configured to determine whether the second vehicle 204 is moving in the same lane as the vehicle 100. Further, as shown in FIG. 2, when the controller 124 detects that the second vehicle 204 is moving in the same lane as the vehicle 100, the controller 124 detects whether the intensity of light from the headlamps 206 of the second vehicle 204, as detected by the high-beam sensor 114, is higher than a threshold value. If the controller detects that the light from the headlamps 206 of the second vehicle 204 is higher than the threshold, then the controller 124 deactivates the high-beam lamp state of the headlamps 112.

Referring to FIG. 3, when the light intensity from the headlamps 206 of the second vehicle 204 is high, as detected by the high beam sensor 114, and the stray light intensity as detected by the stray light sensors 116, 118 is also high, then the controller 124 may not deactivate the high beam lamp state of the headlamps 112. Further, the controller 124 also takes into account the speed of the vehicle 100, the speed of the second vehicle 204, intensity of lights from the headlamps 206, the stray light sources 302, etc., to selectively deactivate the high-beam lamp state of the headlamps 112 of the vehicle 112.

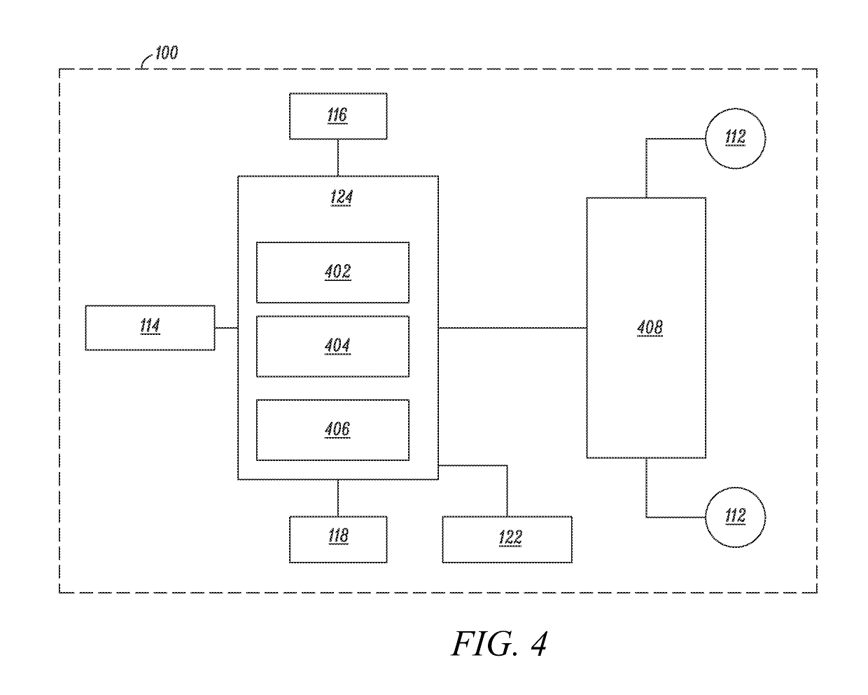

Referring to FIG. 4, the controller 124 may include a processing unit 402, a memory module 404 and a fault detection unit 406. As explained previously, the high beam sensor 114, the stray light sensors 116, 118 and the ground speed sensor 122 provide the first output signal, the second output signal and the speed signal respectively to the controller 124. It is envisioned that the present disclosure includes an auto dipping system 408 associated with the headlamps 112 of the vehicle 100. The auto dipping system 408 is operatively coupled to the controller 124, such that the controller 124 operates the auto dipping system 408 to activate and deactivate the high beam lamp state of the headlamps 112. It is contemplated that the auto dipping system 408 may include an auto ON/OFF switch configured to receive control signals from the controller 124 and selectively activate and/or deactivate the high-beam lamp state of the headlamp 112.

The fault detection unit 406 is configured to receive the first and the second output signals from the high beam sensor 114 and the stray light sensors 116, 118 respectively. Further, the fault detection unit 406 is configured to detect a first output voltage frequency VF1 and a second output voltage frequency VF2 corresponding to the first output signal and the second output signal, respectively. The fault detection unit 406 may detect a fault associated with the high beam sensor 114 and the stray light sensors 116, 118 based on VF1 and VF2. For example, if the first output voltage frequency VF1 and/or the second output voltage frequency VF1 have a non-pulsed output or non-square waveform, then the fault detection unit 406 may detect a fault associated with the respective sensor. The controller 124 may alert an operator of the vehicle 100 by using the operator input devices within the operator cab 110 about the fault in the high-beam sensor 114, and/or the stray light sensors 116, 118 as detected by the fault detection unit 406.

Further, the fault detection unit 406 is configured to send the first and the second output voltage frequencies VF1 and VF2 to the processing unit 402 of the controller 124. The processing unit 402 is configured to compare the first output voltage frequency VF1 with a first threshold frequency TF1. If the first output voltage frequency VF1 is less than the first threshold frequency TF1, then the processing unit 402 detects darkness and the high-beam lamp state is remained activated.

However, if the first output voltage frequency VF1 is greater than the first threshold frequency TF1, then the processing unit 402 compares the second output voltage frequency VF2 with a second threshold frequency TF2. It may be contemplated that the second output voltage frequency VF2 is based on the intensity of the stray lights detected by the stray light sensors 116, 118. Further, the controller 124 is configured to control the auto dipping system 408 to deactivate the high beam lamp state of the headlamps 112 when the first output voltage frequency VF1 is greater than the first threshold frequency TF1 and the second output voltage frequency VF2 is less than the second threshold frequency TF2. This means, when the intensity of light from the headlamps 206 of the second vehicle 204 is greater than the intensity of the stray lights from the stray light source 302, then the controller 124 controls the auto dipping system 408 to deactivate the high beam lamp state of the headlamps 112.

The first and the second threshold frequencies TF1 and TF2 may be pre-stored in the memory module 404. The memory module 404 may be an internal and/or an external database of any known configuration. The memory module 404 may be internal to the vehicle 100 or external to the vehicle 100. Further, the memory module 404 may employ any type of database, such as relational, hierarchical, graphical, object-oriented, and/or other database configurations. The processing unit 402 may extract the data stored in the memory module 404 as and when required.

The processing unit 402 is further configured to determine whether the vehicle 100 is moving. For example, the processing unit 402 receives the speed signal from the ground speed sensor 122 to determine whether the vehicle 100 is moving. The processing unit 402 is configured to compare the intensity of light from the headlamps 206 with the intensity of light from the stray light source 302 when the vehicle is not moving, i.e., when the speed of the vehicle 100 is zero. Furthermore, the processing unit 402 is configured to control the auto dipping system 408 to deactivate the high beam lamp state of the headlamps 112 when the intensity of light from the headlamps 206 is greater than the intensity of light from the stray light source 302. However, when the intensity of light from the headlamps 206 is less than the intensity of light from the stray light source 302, then the processing unit 402 activates the high-beam lamp state of the headlamps 112.

Furthermore, the processing unit 402 is configured to determine the rate of increase (ROI) of intensity of the light from the headlamps 206 of the second vehicle 204 and the ROI of the intensity of the stray lights from the stray light sources 302, when the vehicle 100 is moving. The processing unit 402 is configured to compare the ROI of intensity of light from the headlamps 206 with the ROI of intensity of the light from the stray light source 302, when the vehicle 100 is moving. Further, when the ROI of intensity of light from the headlamps 206 is less than the ROI of intensity of the light from the stray light source 302, then the processing unit 402 is configured to activate the high-beam state of the headlamps 112.

When the ROI of intensity of light from the headlamps 206 is greater than the ROI of intensity of the light from the stray light source 302, then the processing unit 402 is configured to determine a relative velocity of the second vehicle 204 with respect to the vehicle 100. For example, the processing unit 402 determines the relative velocity of the second vehicle 204 with respect to the vehicle 100 based on the speed signal from the ground speed sensor 122 and the ROI of intensity of the light from the headlamps 206 of the second vehicle 204.

When the relative velocity of the second vehicle 204 with respect to the vehicle 100 is greater than zero, i.e., when the second vehicle 204 is moving, the processing unit 402 is configured to control the auto dipping system 408 to deactivate the high-beam lamp state of the headlamps 112 of the vehicle 100. However, when the relative velocity of the second vehicle 204 with respect to the vehicle 100 is zero, i.e., when the second vehicle 204 is stationary, the processing unit 402 is configured to control the auto dipping system 408 to activate the high-beam lamp state of the headlamps 112 of the vehicle 100.

### INDUSTRIAL APPLICABILITY

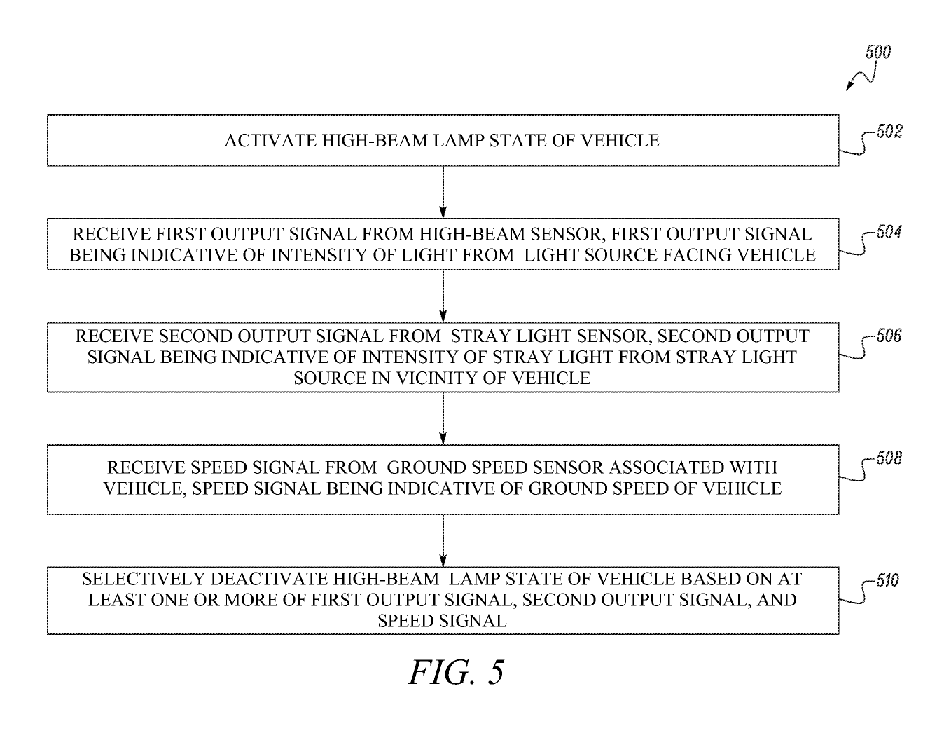

FIG. 5 illustrates a flowchart of an exemplary method 500 for controlling the high-beam lamp state of the headlamps 112 of the vehicle 100. Initially, at step 502, the controller 124 activates the high-beam lamp state of the head lamps 112. In an embodiment, the controller 124 communicates with the auto-dipping system 408 of the vehicle 100 to activate the high-beam lamp state of the headlamps 112.

At step 504, the controller 124 receives a first output signal from the high-beam sensor 114. In an exemplary embodiment, the first output signal is indicative of an intensity of light from the light source facing the vehicle 100, i.e., from the headlamps 206 of the second vehicle 204 approaching the vehicle 100.

At step 506, the controller 124 receives a second output signal from the stray light sensors 116, 118. In an exemplary embodiment, the second output signal is indicative of an intensity of light from the stray light sources 302. The high-beam sensor 114, and the stray light sensors 116, 118 are active sensors that receive light intensity as input and provide a pulsed output or a variable frequency output signal as output corresponding to the light intensity. Use of the light sensors configured to output the PWM signal or the variable frequency output signal provides an accurate measurement of the intensity of lights from the headlamps 206 of other vehicles as well as the lights from the stray light sources such as the stray light source 302.

Further, the controller 124 detects the first output voltage frequency VF1 and the second output voltage frequency VF2 corresponding to the first output signal and the second output signal, respectively. In an embodiment, the controller 124 detects a fault associated with the high beam sensor 114 and/or the stray light sensors 116, 118 based on VF1 and VF2. For example, if the first output voltage frequency VF1 and/or the second output voltage frequency VF1 have a non-square waveform, then the controller 124 detects a fault associated with the respective sensor. Further, the controller 124 alerts the operator of the vehicle 100 about the faulty sensor using the operator input devices within the operator cab 110. Therefore, the faulty sensors may be replaced quickly and thereby reducing the risk of inaccurate measurements of light intensities.

At step 508, the controller 124 receives a speed signal from the ground speed sensor 122. In an exemplary embodiment, the speed signal is indicative of the ground speed of the vehicle 100.

Furthermore, at step 510, the controller 124 selectively deactivates the high-beam lamp state of the headlamps 112 of the vehicle 100 based on the first output signal, the second output signals and/or the speed signal. The selective deactivation of the high-beam lamp state of the headlamps 112 is automatic and therefore, minimizes human intervention. Therefore, the system ensures safety of the operator driving the vehicle 100 and avoids glare-induced accidents during night-time driving.

In an embodiment, the controller 124 compares the first output voltage frequency VF1 with the first threshold frequency TF1. If the first output voltage frequency VF1 is less than the first threshold frequency TF1, then the controller 124 detects darkness and the high-beam lamp state is remained activated.

However, if the first output voltage frequency VF1 is greater than the first threshold frequency TF1, then the controller 124 compares the second output voltage frequency VF2 with a second threshold frequency TF2. Further, the controller 124 deactivates the high beam lamp state of the headlamps 112 when the first output voltage frequency VF1 is greater than the first threshold frequency TF1 and the second output voltage frequency VF2 is less than the second threshold frequency TF2.

In an exemplary embodiment, the first and the second threshold frequencies TF1 and TF2 may be based on distance of the vehicle 100 from the second vehicle 204, such that the distance is a safe distance before which the vehicle 100 needs to either stop or deactivate the high-beam lamp state to avoid any possible accidents. It may be contemplated, that these TF1 and TF2 may be predefined according to safety standards known for operating the vehicle 100.

Further, the controller 124 determines whether the vehicle 100 is moving or not based on the speed signal received from the ground speed sensor 122. In an exemplary embodiment, the controller 124 compares the intensity of light from the headlamps 206 with the intensity of light from the stray light source 302 when the vehicle is not moving, i.e., when the speed signal indicates that the speed of the vehicle 100 is zero. Furthermore, the controller 124 deactivates the high beam lamp state of the headlamps 112 when the intensity of light from the headlamps 206 is greater than the intensity of light from the stray light source 302. However, when the intensity of light from the headlamps 206 is less than the intensity of light from the stray light source 302, then the controller 124 activates the high-beam lamp state of the headlamps 112.

Furthermore, the controller 124 determines and compares the rate of increase (ROI) of intensity of the light from the headlamps 206 of the second vehicle 204 and the ROI of the intensity of the stray lights from the stray light sources 302, when the vehicle 100 is moving. Further, when the ROI of intensity of light from the headlamps 206 is less than the ROI of intensity of the light from the stray light source 302, then the controller 124 activates the high-beam state of the headlamps 112.

When the ROI of intensity of light from the headlamps 206 is greater than the ROI of intensity of the light from the stray light source 302, then the controller 124 determines a relative velocity of the second vehicle 204 with respect to the vehicle 100. For example, the controller 124 determines the relative velocity of the second vehicle 204 with respect to the vehicle 100 based on the speed signal from the ground speed sensor 122 and the ROI of intensity of the light from the headlamps 206 of the second vehicle 204.

When the relative velocity of the second vehicle 204 with respect to the vehicle 100 is greater than zero, i.e., when the second vehicle 204 is moving, the controller 124 deactivates the high-beam lamp state of the headlamps 112 of the vehicle 100. However, when the relative velocity of the second vehicle 204 with respect to the vehicle 100 is zero, i.e., when the second vehicle 204 is stationary, the controller 124 activates the high-beam lamp state of the headlamps 112 of the vehicle 100.

The controller 124 ensures immunity to stray lights from the stray light sources 302, to ensure accuracy in deactivating the high-beam lamp state of the headlamps 112, thereby minimizing errors. Further, the system is cost efficient and easy to implement.

While aspects of the present disclosure have been particularly shown and described with reference to the embodiments above, it will be understood by those skilled in the art that various additional embodiments may be contemplated by the modification of the disclosed vehicles, systems and methods without departing from the spirit and scope of what is disclosed. Such embodiments should be understood to fall within the scope of the present disclosure as determined based upon the claims and any equivalents thereof.

What is claimed is:

1. A method for controlling high-beam lamp state in a vehicle, the method comprising:
activating the high-beam lamp state of the vehicle;
receiving a first output signal from a high-beam sensor, the first output signal being indicative of an intensity of light from a light source facing the vehicle;
receiving a second output signal from a stray light sensor, the second output signal being indicative of an intensity of stray light from a stray light source in vicinity of the vehicle;
receiving a speed signal from a ground speed sensor associated with the vehicle, the speed signal being indicative of a ground speed of the vehicle; and
selectively deactivating the high-beam lamp state of the vehicle based on at least one or more of the first output signal, the second output signal, and the speed signal.

2. The method of claim 1, wherein the first and the second output signals are at least one of a Pulse Width Modulated (PWM) signal and a variable frequency signal.

3. The method of claim 1 further comprising detecting a first output voltage frequency and a second output voltage frequency corresponding to the first output signal and the second output signal, respectively.

4. The method of claim 3 further comprising comparing the first output voltage frequency with a first threshold frequency.

5. The method of claim 4 further comprising comparing the second output voltage frequency with a second threshold frequency.

6. The method of claim 5 further comprising deactivating the high-beam lamp state of the vehicle when the first output voltage frequency is greater than the first threshold frequency and the second output voltage frequency is less than the second threshold frequency.

7. The method of claim 1 further comprising determining a rate of increase of intensity of light from the light source facing the vehicle and a rate of increase of intensity of stray light from the stray light source.

8. The method of claim 7 further comprising comparing the rate of increase of intensity of light from the light source facing the vehicle with the rate of increase of intensity of stray light from the stray light source when the ground speed of the vehicle is greater than zero.

9. The method of claim 8 further comprising determining a relative velocity of the light source facing the vehicle with respect to the vehicle when the rate of increase of intensity of light from the light source facing the vehicle is greater than the rate of increase of intensity of stray light from the stray light source.

10. The method of claim 9 further comprising deactivating the high-beam lamp state of the vehicle when the relative velocity of the light source facing the vehicle with respect to the vehicle is greater than zero.

11. A controller for an auto-dipping system associated with a head lamp of a vehicle, controller configured to:
detect activated high-beam lamp state of the vehicle;
receive a first output signal from a high-beam sensor, the first output signal being indicative of an intensity of light from a light source facing the vehicle;
receive a second output signal from a stray light sensor, the second output signal being indicative of an intensity of stray light from a stray light source in vicinity of the vehicle;
receive a speed signal from a ground speed sensor associated with the vehicle, the speed signal being indicative of a ground speed of the vehicle; and
selectively deactivate the high-beam lamp state of the vehicle based on at least one or more of the first output signal, the second output signal, and the speed signal.

12. The controller of claim 11, wherein the first and the second output signals are at least one of a Pulse Width Modulated (PWM) signal and a variable frequency signal.

13. The controller of claim 11 comprising a fault detection unit, the fault detection unit configured to detect a first output voltage frequency and a second output voltage frequency corresponding to the first output signal and the second output signal, respectively.

14. The controller of claim 13 further comprising a processing unit, the processing unit being configured to compare the first output voltage frequency with a first threshold frequency.

15. The controller of claim 14, wherein the processing unit is configured to compare the second output voltage frequency with a second threshold frequency.

16. The controller of claim 14, wherein the processing unit is configured to deactivate the high-beam lamp state of the vehicle when the first output voltage frequency is greater than the first threshold frequency and the second output voltage frequency is less than the second threshold frequency.

17. The controller of claim 15, wherein the processing unit is configured to determine a rate of increase of intensity of light from the light source facing the vehicle and a rate of increase of intensity of stray light from the stray light source.

18. The controller of claim 17, wherein the processing unit is configured to comparing the rate of increase of intensity of light from the light source facing the vehicle with the rate of increase of intensity of stray light from the stray light source when the ground speed of the vehicle is greater than zero.

19. The controller of claim 18, wherein the processing unit is configured to determine a relative velocity of the light source facing the vehicle with respect to the vehicle when the rate of increase of intensity of light from the light source facing the vehicle is greater than the rate of increase of intensity of stray light from the stray light source.

20. The controller of claim 19, wherein the processing unit configured to deactivate the high-beam lamp state of the vehicle when the relative velocity of the light source facing the vehicle with respect to the vehicle is greater than zero.
